(19) United States
(12) Patent Application Publication
(10) Pub. No.: US 2022/0309587 A1
(43) Pub. Date: Sep. 29, 2022

(54) ASSET ASSESSMENT VIA LATTICE-BASED LIABILITY ENCODING

(71) Applicant: International Business Machines Corporation, Armonk, NY (US)

(72) Inventors: Mohan Nagraj Dani, Bangalore (IN); Balaji Rishi Sundarajan, Hyderabad (IN); Sharath C Athrey, Bangalore (IN)

(21) Appl. No.: 17/210,473

(22) Filed: Mar. 23, 2021

(51) Int. Cl. G06Q 40/08; G06Q 10/06; G06Q 40/06; G06N 3/08

(52) U.S. Cl. CPC G06Q 40/08; G06Q 10/067; G06Q 40/06; G06N 3/08

(57) ABSTRACT

Three lattice that includes nodes of liability factors across time are generated. The first lattice includes liability factors related to an asset, the second lattice includes liability factors related to an asset owner across time, and the third lattice includes liability factors related to economic parameters. The three lattices are combined to generate a single polynomial lattice. Liability scenarios of the asset are simulated by capturing traversal of polynomial lattice. A risk score of the asset is determined by analyzing the simulated liability scenarios.

### BACKGROUND

Many factors may be used to determine an overall value and/or liability of an asset. For example, an asset could be a thing that could be bought, invested in, insured, or the like. An organization may desire to acquire one of these assets (such as by purchasing the asset, investing in the asset, insuring the asset, etc.), and may therefore have a desire to evaluate the value and/or liability of the asset. However, it may be an extremely difficult and nuanced evaluation to weigh each of the factors required to determine a true value and/or risk of an asset. For example, an asset may have dozens of factors of varying magnitudes that interrelate in different ways to have different impacts upon a value and/or risk of an asset.

### SUMMARY

Aspects of the present disclosure relate to a method, system, and computer program product relating to risk analysis for an asset via generation of numerous lattices that are combined together to make a polynomial lattice for that asset. For example, the method includes generating a first lattice that includes nodes of liability factors related to an asset across time. The method also includes generating a second lattice that includes nodes of liability factors related to an asset owner across time. The method also includes generating a third lattice that includes nodes of liability factors related to economic parameters across time. The method also includes combining the first and second and third lattice into a single polynomial lattice. The method also includes simulating liability scenarios by capturing traversal of the polynomial lattice. The method also includes determining a risk score of the asset by analyzing the simulated liability scenarios. A system and computer product configured to perform the above method are also disclosed.

The above summary is not intended to describe each illustrated embodiment or every implementation of the present disclosure.

### BRIEF DESCRIPTION OF THE DRAWINGS

The drawings included in the present application are incorporated into, and form part of, the specification. They illustrate embodiments of the present disclosure and, along with the description, serve to explain the principles of the disclosure. The drawings are only illustrative of certain embodiments and do not limit the disclosure.

FIG. 1 depicts a conceptual diagram of one embodiment of a computing environment in which a controller generates lattices of various aspects of assets and simulates traversals of a combined polynomial lattice of these individual lattices to evaluate a liability of these assets.

FIG. 2 depicts an example polynomial lattice that may be generated by the controller of FIG. 1.

FIG. 3 depicts an example conceptual box diagram of the controller of FIG. 1.

FIG. 4 depicts a flowchart of an example method of simulating traversals of a polynomial lattice of various aspects of assets in order to determine a risk score of the asset.

While the invention is amenable to various modifications and alternative forms, specifics thereof have been shown by way of example in the drawings and will be described in detail. It should be understood, however, that the intention is not to limit the invention to the particular embodiments described. On the contrary, the intention is to cover all modifications, equivalents, and alternatives falling within the spirit and scope of the invention.

### DETAILED DESCRIPTION

Aspects of the present disclosure relate to evaluating assets, while more particular aspects of the present disclosure relate to generating numerous lattices that reflect different respective dimensions of economic liability and/or worth of an asset, such that these different lattices are combined together into a single polynomial lattice which is traversed to evaluate the asset. While the present disclosure is not necessarily limited to such applications, various aspects of the disclosure may be appreciated through a discussion of various examples using this context.

A person or organization may want to acquire an asset. For example, a person or organization may want to purchase an asset that can be owned, invest in an asset over a period of time, insure an asset, or the like. As used herein, “acquiring an asset” may relate to an action in which a person gains some economic stake in the asset. For example, an asset may include a collateralized debt obligation (CDO) of a plurality of loans that a person is considering investing in, such that a user must consider a risk of the CDO (and therein a risk of some or all of the loans, each of which have a plurality of factors that impact the risk of the loans) before deciding to acquiring a stake in the CDO. For another example, an asset may include a property such as a house, the asset may include a business loan (where the organization is the bank, and liability factors may include factors that make it less likely that the business loan will be repaid), or the asset may include a shipping voyage (where the organization is insuring or purchasing a take in the shipping voyage, and the liability factors include factors that make it less likely that the shipping voyage will arrive on time with all of the goods undamaged).

Before acquiring an asset, a potential investor/purchaser might attempt to determine a risk and value of the asset. In some cases, it may be relatively easy to find out a current value of the asset, but it may be relatively difficult to determine the risk, and it may also be relatively difficult to determine a future value and/or risk of the asset. For example, there may be a great multitude of factors from the past, the present, and the future that impact a current or potential future liability of an asset, and these factors may interrelate in unexpected and unpredictable ways.

As such, even with current conventional asset acquisition tools that aid in cataloguing various risk factors, it may be difficult for a person to identify which assets are worth acquiring in a quick timeframe. Rather, it may require the assistance of a highly trained and specialized analyst that is specifically trained to analyze each of the different asset categories, and this analyst may need to look at and consider each risk factor that is catalogued within the conventional asset acquisition tool. Further, in some examples an asset may include a plurality of sub-assets that themselves all include liability factors, such as the aforementioned CDO of a plurality of loans. Each of these may have myriad factors that impact liabilities, such as historical factors (e.g., historical credit scores, interest rates), current factors (e.g., current geopolitical considerations, credit scores), future factors (e.g., a planned end date for a loan or shipping voyage) that may relate to the asset itself (e.g., terms or conditions of a loan), a borrower behind the asset (e.g., an income-to-debt ratio of a business asking for a loan), any natural hazards that may relate to the asset (e.g., wildfires/earthquakes/tornadoes that relate to a location associated with the asset, or pandemics that are in an area associated with the asset), or the like.

Some conventional asset acquisition tools involve trying to account for many and/or all of these factors, such as by coding these factors into a number of different structures and executing a number of calculations that account for most or all of these factors. For example, a conventional asset acquisition tool may be configured to use a stochastic model on a group of datasets that include all factors and variables in order to quantify and qualify most or all things that may impact a liability and/or worth of an asset now and/or in the future. However, the further out into the future and the more complex the asset the more computationally intensive the analysis will take, such that a conventional asset acquisition tool may be unable to execute the analysis at all, unable to execute the analysis in a reasonable amount of time, and/or unable to execute the process with a threshold amount of confidence.

Aspects of this disclosure relate to systems and methods that eliminate and/or reduce these technical problems of conventional asset acquisition tools. For example, aspects of this disclosure are configured to generate a plurality of lattices that reflect different dimensions of liability of an asset (e.g., a first lattice regarding the asset itself, the second lattice regarding the asset owner, and a third asset regarding economic parameters), where these lattices are then combined so that a computer system may traverse a single generated polynomial lattice to better analyze and isolate respective liability factors to determine and provide a risk score of an asset. One or more computing controllers that include one or more processors executing instructions stored on one or more computing memories (these computing controllers discussed generically herein as a single computing controller) may generate this polynomial lattice that is traversed to determine a liability score of an asset.

A controller may generate such a polynomial lattice with little or no help from a trained user. For example, a controller may gather liability data related to an asset from one or more sources and structure this data into a series of lattices according to predetermined techniques that uniquely identify and quantify these liability factors. The controller may then calculate liability scores of the asset via simulations of liability scenarios as the controller traverses through the polynomial lattice, where these scores may be merged or averaged together into a final score. The controller may use a neural network or the like to generate polynomial lattices and/or traverse these polynomial lattices. The controller may be faster and more accurate at accounting for how the different dimensions of liability of an asset interact over time via traversing this polynomial lattice, such that aspects of the disclosure may improve a technical ability of accounting for liability factors when calculating a risk of an asset.

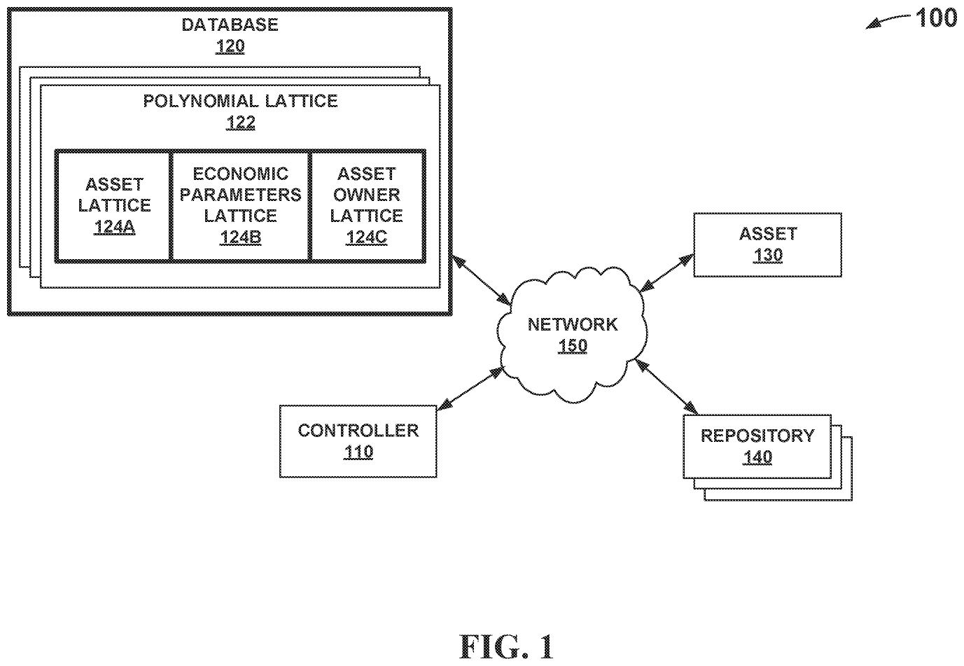

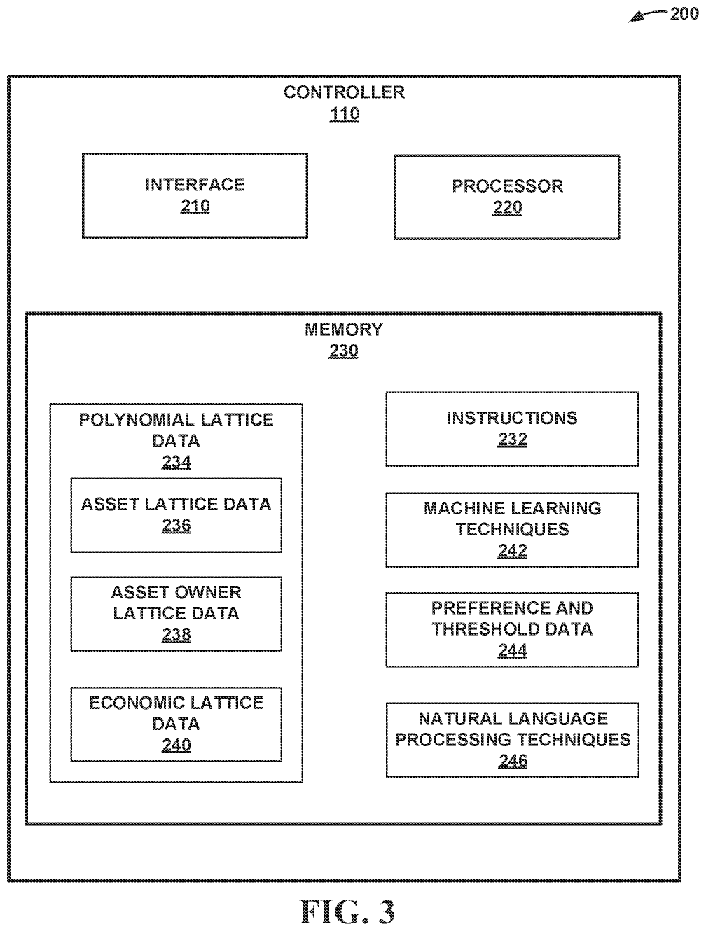

For example, FIG. 1 depicts environment 100 that includes controller 110 that is configured to generate polynomial lattice 122 that represents possible liability scenarios for asset 130. Controller 110 may include a computing device, such as computing device 200 of FIG. 3 that includes a processor communicatively coupled to a memory that includes instructions that, when executed by the processor, cause controller 110 to execute the operations described below.

Controller 110 may generate polynomial lattice 122 for asset 130 that includes one or more asset lattices 124A, one or more economic parameters lattices 124B, and/or one or more asset owner lattices 124C. In some examples, controller 110 may generate this polynomial lattice 122 in response to receiving a request from a user device (not depicted) to generate polynomial lattice 122 for asset 130. As discussed herein, asset 130 may be a thing that a person or organization may acquire (e.g., purchase or monetize an involvement in). As depicted, controller 110 may store polynomial lattice 122 within database 120, which may include a substantial number of polynomial lattices 122.

Controller 110 may determine one or more liability factors of asset 130, where each of these liability factors may impact a liability and/or value of asset 130. For example, liability factors may make it more or less likely that an organization may be able to successfully monetize (e.g., profit by investing in and/or buying) asset 130, and/or liability factors may change a rate and/or manner of involvement at which an organization is able to successfully monetize asset 130. Liability factors may relate to asset 130 itself (e.g., business terms of asset 130, a quality of asset 130, a history of asset 130), they may relate to an entity associated with asset 130 where this entity is referred to herein as an asset owner (e.g., a credit score of a business that is categorized as a owner of asset 130, an industry of asset 130 owner, etc.), and/or liability factors may relate to environmental factors such as economic factors that impact asset 130 (e.g., interest rates).

For example, asset 130 may include a loan of some variety that an organization may monetize by insuring (e.g., where the organization is an insurer) or investing in (e.g., where the organization is an investment agency). The loan may be on a commercial/personal property, the loan may be a business loan, etc. In such an example, liability factors may impact a likelihood of the loan being paid off on time, being paid off ahead of schedule, the asset 130 becoming “underwater” (such that a worth of asset 130 is less than liabilities associated with asset 130), or the like. For another example, asset 130 may include a shipping voyage that an organization is considering sponsoring/insuring/investing in, and liability factors may impact a likelihood of the shipment arriving at its destination according to a predicted schedule with all of the goods in a predetermined condition.

In some examples, controller 110 may receive all of this information of liabilities of asset 130 in a single message. For example, controller 110 may receive a single message that includes a form with asset 130 and liability data. In other examples, controller 110 may crawl across one or more repositories 140 to gather liability data. For example, controller 110 may receive a request relating to asset 130 that indicates a business, with which controller 110 utilizes a credit score repository 140 to determine a credit score that is currently associated with the business (e.g., as well as a full credit report that includes past credit scores based on past credit history). Similarly, if controller 110 receives a request relating to asset 130 of shipping voyage across a particular shipping route, controller 110 may gather data relating to weather and incident reports from respective repositories 140 on these subjects. Controller 110 may use natural language processing (NLP) techniques as known in the art to ingest this data once discovered.

Once controller 110 gathers this data, controller 110 generates two-dimensional lattices 124A-124C to reflect liability factors across various dimensions. Controller 110 may generate asset lattice 124A (that captures possible liability factors relating to asset 130 itself as these liability factors may change over time), economic parameters lattice 124B (that captures possible liability factors relating to the economy as these economic factors may change over time), and asset owner lattice 124C (that captures possible liability factors relating to an owning entity of asset 130 as these owner liability factors may change over time). For example, controller 110 may generate each of lattices 124 such that these lattices 124 each include a plurality of nodes connected by a plurality of connections that stretch forward and/or backwards across time, where each node is a possible liability factor that may be realized at that respective point in time (e.g., a weather event or an economic bull market or the like), and/or that nodes indicates a possible “value” of a liability factor at that respective point in time (e.g., a respective interest rate or credit score). Controller 110 may generate respective lattices 124 such that values of nodes logically flow into each other such that it is likely that a value of one node would occur sequentially to adjacent nodes (e.g., such that a node that represented an interest of 5.1% would be adjacent a node that represented an interest rate of 5.2%, and a node that represented an interest rate of 6.5% would have numerous nodes between itself and the nodes of 5.1% and 5.2%).

As discussed herein, controller 110 may combine lattices 124 to create a three-dimensional polynomial lattice 122 that itself reflects how all liability factors of all lattices 124 relate together over time. In some examples, polynomial lattice 122 as created by controller 110 may include a single asset lattice 124A, a single economic lattice 124B, and a single asset owner lattice 124C. In other examples (not depicted) polynomial lattice will only not include one of asset lattice 124A, economic parameters lattice 124B, and/or asset owner lattice 124C (e.g., such that polynomial lattice 122 may only include, e.g., asset lattice 124A and asset owner lattice 124C, and not include economic parameters lattice 124B). Further, in some examples, controller 110 may create polynomial lattice 122 such that it includes a plurality of asset lattices 124A, economic parameters lattices 124B, and/or asset owner lattices 124C. Though most of the discussion contained herein refers to polynomial lattice 122 with a single asset lattice 124A, a single economic parameters lattice 124B, and a single asset owner lattice 124C for the sake of clarity, any number or inclusion of different lattices that reflect different dimensions of asset 130 over time may be included within polynomial lattice 122.

Controller 110 may access repositories 140 and database 120 over network 150. Network 150 may include a computing network over which computing messages and/or computing data may be sent and/or received. For example, network 150 may include the Internet, a local area network (LAN), a wide area network (WAN), a wireless network such as a wireless LAN (WLAN), or the like. Network 150 may comprise copper transmission cables, optical transmission fibers, wireless transmission, routers, firewalls, switches, gateway computers and/or edge servers. A network adapter card or network interface in each computing/processing device (e.g., controller 110, database 120, and/or repositories 140) may receive messages and/or instructions from and/or through network 150 and forward the messages and/or instructions for storage or execution or the like to a respective memory or processor of the respective computing/processing device.

Though network 150 is depicted as a single entity in FIG. 1 for purposes of illustration, in other examples network 150 may include a plurality of private or public networks. For example, controller 110 and database 120 may communicate together over a private LAN of network 150 (e.g., as these two may be part of an organization that provides risk analysis capabilities for users). For another example, controller 110 may receive information from/regarding asset 130 through a coupling to a separate private WLAN that corresponds to respective assets 130 (e.g., where a business user sends a request regarding asset 130 to controller 110 from a private WLAN of the business over network 150). Additionally, controller 110 may gather data related to users from repositories 140 over a public portion of network 150 using the Internet.

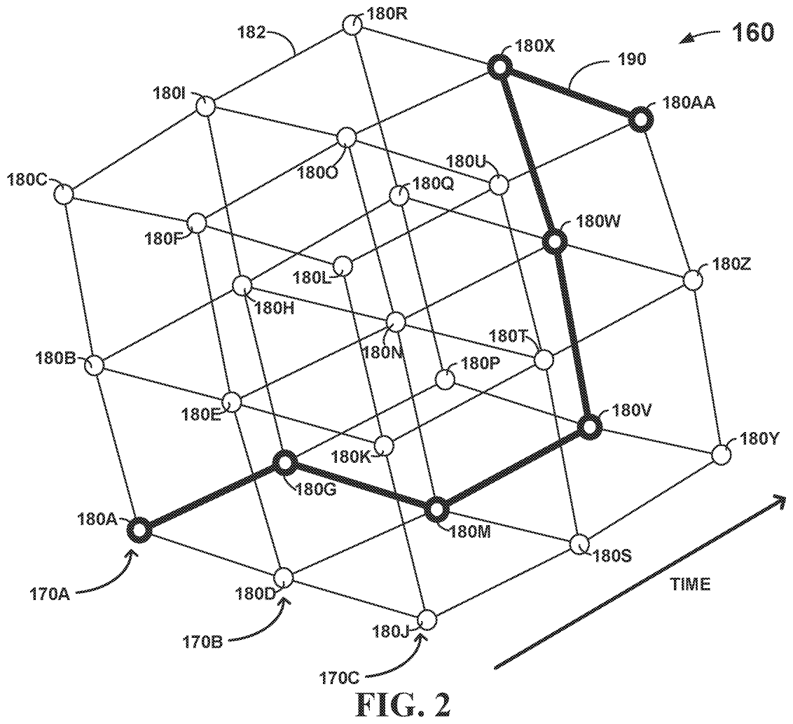

FIG. 2 depicts an example polynomial lattice 160. Polynomial lattice 160 includes a plurality of lattices 170A-170C (collectively, “lattices 170”) made of a plurality of nodes 180A-180AA (collectively, “nodes 180”) that are connected via a plurality of connections 182. For example, as depicted, lattice 170A includes nodes 180A, 180B, 180C, 180G, 180H, 180I, 180P, 180Q, and 180R. Further, as depicted, lattice 170B includes nodes 180D, 180E, 180F, 180M, 180N, 1800, 180V, 180W, and 180X. Further, as depicted, lattice 170C includes nodes 180J, 180K, 180L, 180S, 180T, 180U, 180Y, 180Z, and 180AA. Though each of the three lattices 170 include nine nodes 180 apiece as depicted within polynomial lattice 160 of FIG. 2, it is to be understood that in other examples controller 110 may create different versions of polynomial lattices 160 that include more or less lattices 170, where each lattice 170 may include more or less nodes 180.

As discussed, each of lattices 170 may reflect a different dimension of liability of asset 130. For example, lattice 170A may be asset lattice 124A, whereas lattice 170B is economic parameters lattice 124B, and lattice 170C is asset owner lattice 124C. Though for the sake of clarity each of lattices 170 are depicted as including an equal amount of nodes 180 at respective points in time for the sake of illustration, it is to be understood that in reality polynomial lattice 160 as generated by controller 110 may include different nodes 180 for different lattices 170 at different points in time to reflect the different liability factors that these lattices 180 may include at different points in time. For example, some lattices 170 that relate to liability factors that are understood to be random “act of god” type unpredictable events (e.g., such as weather or the like) may have more intermittent nodes 180 or cyclical nodes 180, whereas other lattices 170 that reflect things that tend to predictably and steadily change over time (e.g., interest rates) may have a relatively more consistent arrangement of nodes 180 over time (e.g., where time is reflected by the time axis of FIG. 2).

Once controller 110 generates polynomial lattice 160 that reflects possible liability factors of asset 130 over time, controller 110 traverses through polynomial lattice 160 to evaluate asset 130. For example, controller 110 may traverse through polynomial lattice 160 along path 190. Path 190 may reflect a simulated liability scenario, such that by traversing along path 190 controller 110 may determine a value and/or liability of asset 130 according to that scenario. For example, path 190 may reflect a number of values of respective nodes 180A, 180G, 180M, 180V, 180 W, 180X, 180AA that were included in path 190.

In some examples, path 190 as depicted in FIG. 2 includes only traversing between adjacent nodes 180. For example, controller 110 may generate polynomial lattices 160 such that respective adjacent nodes 180 are related, such that it is realistic, possible, and/or likely for a simulation that includes traversal along adjacent nodes 180 to reflect an accurate real-world situation. In other examples, controller 110 may simulate liability scenarios by different forms of traversing across polynomial lattice 160 (e.g., traversing between any two nodes 180 that share the same or incremental moments of time, whether or not these two nodes are adjacent on respective lattices 170).

Controller 110 may traverse polynomial lattice 160 a threshold number of times. For example, controller 110 may traverse polynomial lattice 160 a hundred times, a thousand times, ten thousand times, or the like. In some examples, controller 110 may traverse polynomial lattice 160 a threshold number of times, and/or when going to some nodes 180 or some regions of polynomial lattice 160 a threshold number or percent of times. For example, controller 110 may be configured to go to a respective lattice 170 that reflects act-of-god type events in no more than 5% and in no less than 2% of simulations, and/or controller 110 may be configured to go to respective nodes 180 that indicate high and low interest rates within at least 25% of simulations.

Controller 110 may use machine learning techniques such as those described herein to learn how to create polynomial lattice 160 and also how to simulate liability scenarios by capturing paths 190 of traversal of polynomial lattice 160. For example, controller 110 may use a neural network to execute an unsupervised clustering technique (e.g., when comparing all created polynomial lattices 122 within database 120 and eventual values/liabilities of realized assets) to determine what individual lattices 170 should look like, and/or how these individual lattices 170 should be combined to generate polynomial lattice 160. For example, controller 110 may determine that some values are worth putting into lattices 160 as nodes 180 with more or less granularity as these different values have more substantial effects over time. Put differently, controller 110 may use a neural network or the like to determine which liability factors as realized as nodes 180 within lattices 170 of generated polynomial lattice 160 have the most impact on a risk score of asset 130 and may therein provide more of these types of nodes 180 (and therein create more potential paths 190 to traverse) in order to allow for more realistic simulations.

Further, as described above, controller 110 may use machine learning techniques as described herein to improve at traversing along polynomial lattice 160. For example, controller 110 may include a neural network where supervised learning techniques are used to teach controller 110 to consider or ignore certain types of paths 190. For example, controller 110 may be taught to ignore certain types of paths that are extremely unlikely (e.g., where interest rates stay at a historically low rate for each month of a 10-year period), while also being taught to consider (e.g., have a higher likelihood of traversing) other paths that are relatively likely.

Once controller 110 simulates liability scenarios by traversing polynomial lattice 160 via path 190, controller 110 determines a risk score of asset 130. For example, controller 110 may average together all of the determined risks and values of asset 130 from the various simulations in order to determine the risk score. Controller 110 may compare a determined risk score of asset 130 against a predetermined or received risk appetite of a user as related to asset 130.

For example, controller 110 may identify that a user that is looking to acquire a plurality of assets 130 (e.g., investing in asset 130, or purchasing asset 130, or insuring asset 130) of different types (e.g., a business loan, a CDO, and also some shipping events), where the user has different risk appetites for the different types, such that controller 110 may determine whether or not the calculated risk score passes the different risk appetites for the different assets 130. Where controller 110 determines that a risk score of asset 130 satisfies a threshold of a user, controller 110 may present this asset 130 to the user as a recommended acquisition. For example, controller 110 may receive a request from a user that indicates a hundred assets 130 that the user is interested in acquiring, and controller 110 may identify each of these assets 130 that satisfy the thresholds set by the user. Controller 110 may provide this indication within a user interface of a user device of the user. For example, controller 110 may cause a user interface of a monitor of a computing device (e.g., a laptop or desktop computer) that is associated with the user to provide this recommendation. Controller 110 may interact with this user computing device over network 150.

As described above, controller 110 may include a computing device with a processor configured to execute instructions stored on a memory to execute the techniques described herein. For example, FIG. 3 is a conceptual box diagram of such computing device 200 of controller 110. While computing device 200 is depicted as a single entity (e.g., within a single housing) for the purposes of illustration, in other examples, controller 110 may be stored within computing device 200 that includes two or more discrete physical systems (e.g., within two or more discrete housings). Computing device 200 may include interfaces 210, processor 220, and memory 230. Computing device 200 may include any number or amount of interface(s) 210, processor(s) 220, and/or memory(s) 230.

Computing device 200 may include components that enable controller 110 to communicate with (e.g., send data to and receive and utilize data transmitted by) devices that are external to controller 110. For example, controller 110 may include interface 210 that is configured to enable controller 110 and components within controller 110 (e.g., such as processor 220) to communicate with entities external to controller 110. Specifically, interface 210 may be configured to enable components of controller 110 to communicate with database 120, a computing device sending information on asset 130, repositories 140, or the like. Interface 210 may include one or more network interface cards, such as Ethernet cards, and/or any other types of interface devices that can send and receive information. Any suitable number of interfaces may be used to perform the described functions according to particular needs.

As discussed herein, controller 110 may be configured to determine a risk score of asset 130 via a generated polynomial lattice 160. Controller 110 may utilize processor 220 to determine a risk score by simulating liability scenarios using this polynomial lattice 160. Processor 220 may include, for example, microprocessors, digital signal processors (DSPs), application specific integrated circuits (ASICs), field-programmable gate arrays (FPGAs), and/or equivalent discrete or integrated logic circuits. Two or more of processor 220 may be configured to work together to determine a risk score via a generated polynomial lattice 160.

Processor 220 may generate polynomial lattice 160 of asset 130 in order to determine a risk score of asset 130 according to instructions 232 stored on memory 230 of controller 110. Memory 230 may include a computer-readable storage medium or computer-readable storage device. In some examples, memory 230 may include one or more of a short-term memory or a long-term memory. Memory 230 may include, for example, random access memories (RAM), dynamic random-access memories (DRAM), static random-access memories (SRAM), magnetic hard discs, optical discs, floppy discs, flash memories, forms of electrically programmable memories (EPROM), electrically erasable and programmable memories (EEPROM), or the like. In some examples, processor 220 may generate and analyze liability images according to instructions 232 of one or more applications (e.g., software applications) stored in memory 230 of controller 110.

In addition to instructions 232, in some examples gathered or predetermined data or techniques or the like as used by processor 220 to determine risk scores may be stored within memory 230. For example, memory 230 may include liability data on asset 130 as received and/or gathered by controller 110, and/or may include substantially all of historical polynomial lattice 122 and lattice 124 data stored in database 120. For example, as depicted in FIG. 3, memory 230 may include polynomial lattice data 234, which includes asset lattice data 236, asset owner lattice data 238, and economic lattice data 240. Asset lattice data 236 may include all liability factor data as described herein that relates to asset 130 itself, while asset owner lattice data 238 may include all liability factor data that relates to an owning entity of asset 130, and economic lattice data 240 includes liability factor data that relates to the economy.

Memory 230 may include preference and threshold data 244. For example, preference and threshold data 244 may include data such as risk tolerances of a user, and a threshold that reflects this risk tolerances. Preference and threshold data 244 may also reflect a general value or type of asset 130 that a user is interested in.

Memory 230 may further include machine learning techniques 242 that controller 110 may use to improve a process of generating and analyzing liability images over iterations. Machine learning techniques 242 can comprise algorithms or models that are generated by performing supervised, unsupervised, or semi-supervised training on a dataset, and subsequently applying the generated algorithm or model to determine risk scores by modifying a manner in which polynomial lattices 160 are generated and/or traversed to simulation liability scenarios. Machine learning algorithms can include, but are not limited to, decision tree learning, association rule learning, artificial neural networks, deep learning, inductive logic programming, support vector machines, clustering, Bayesian networks, reinforcement learning, representation learning, similarity/metric training, sparse dictionary learning, genetic algorithms, rule-based learning, and/or other machine learning techniques.

For example, the machine learning algorithms can utilize one or more of the following example techniques: K-nearest neighbor (KNN), learning vector quantization (LVQ), self-organizing map (SOM), logistic regression, ordinary least squares regression (OLSR), linear regression, stepwise regression, multivariate adaptive regression spline (MARS), ridge regression, least absolute shrinkage and selection operator (LASSO), elastic net, least-angle regression (LARS), probabilistic classifier, naïve Bayes classifier, binary classifier, linear classifier, hierarchical classifier, canonical correlation analysis (CCA), factor analysis, independent component analysis (ICA), linear discriminant analysis (LDA), multidimensional scaling (MDS), non-negative metric factorization (NMF), partial least squares regression (PLSR), principal component analysis (PCA), principal component regression (PCR), Sammon mapping, t-distributed stochastic neighbor embedding (t-SNE), bootstrap aggregating, ensemble averaging, gradient boosted decision tree (GBRT), gradient boosting machine (GBM), inductive bias algorithms, Q-learning, state-action-reward-state-action (SARSA), temporal difference (TD) learning, apriori algorithms, equivalence class transformation (ECLAT) algorithms, Gaussian process regression, gene expression programming, group method of data handling (GMDH), inductive logic programming, instance-based learning, logistic model trees, information fuzzy networks (IFN), hidden Markov models, Gaussian naïve Bayes, multinomial naïve Bayes, averaged one-dependence estimators (AODE), Bayesian network (BN), classification and regression tree (CART), chi-squared automatic interaction detection (CHAID), expectation-maximization algorithm, feedforward neural networks, logic learning machine, self-organizing map, single-linkage clustering, fuzzy clustering, hierarchical clustering, Boltzmann machines, convolutional neural networks, recurrent neural networks, hierarchical temporal memory (HTM), and/or other machine learning techniques.

Memory 230 may include NLP techniques 246 that controller 110 may use to identify whether data stored in repositories 140 impact a liability and/or value of asset 130. NLP techniques 246 can include, but are not limited to, semantic similarity, syntactic analysis, and ontological matching. For example, in some embodiments, processor 220 may be configured to parse comments from a news source or the like in repositories 140 to determine semantic features (e.g., word meanings, repeated words, keywords, etc.) and/or syntactic features (e.g., word structure, location of semantic features in headings, title, etc.) of weather data or other types of natural event in an environment of asset 130. Ontological matching could be used to map semantic and/or syntactic features to a particular liability. The concept can then be used to determine the subject matter. In this way, using NLP techniques 246, controller 110 may, e.g., identify publicly available data that impacts a liability of asset 130.

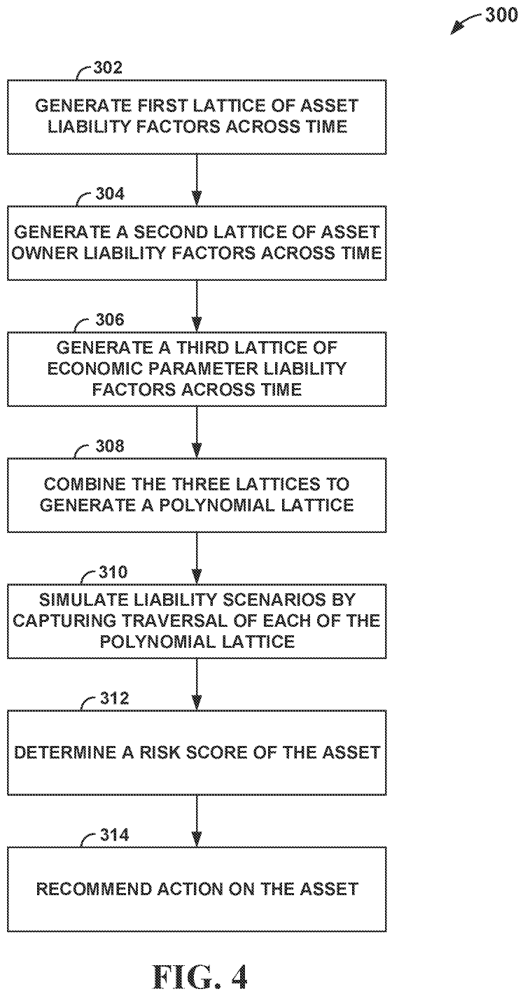

Using these components, controller 110 may determine a risk score of asset 130 via simulating liability scenarios by traversing a generated polynomial lattice 160 as discussed herein. For example, controller 110 may determine a risk score according to flowchart 300 depicted in FIG. 4. Flowchart 300 of FIG. 4 is discussed with relation to FIGS. 1 and 2 for purposes of illustration, though it is to be understood that other systems may be used to execute flowchart 300 of FIG. 4 in other examples. Further, in some examples, controller 110 may determine risk scores differently than flowchart 300 of FIG. 4, or controller 110 may determine risk scores via a similar method with more or less steps in a different order, or the like.

Controller 110 generates asset lattice 124A that reflects asset liability factors across time (302). Controller 110 generates asset owner lattice 124C that reflects asset owner liability factors across time (304). Controller 110 generates economic lattice 124B that reflects economic liability factors across time (306). Controller 110 may generate each of these lattices 124 with different nodes 180 for different liability factors. Controller 110 may identify each of these liability factors of asset 130 that go into each of lattices 124, including determining each of the predicted/potential individual values for each liability factor as represented as nodes within lattices 124. Controller 110 may receive some or all of these liability factors from a request from a user (e.g., a request to determine a risk score of asset 130). Alternatively, or additionally, controller 110 may gather these liability factors itself by crawling through one or more repositories 140, and/or by extrapolating values of liability factors over time after analyzing repositories 140. In some examples, liability factors may include various events that have likelihoods to happen (and/or are predicted to happen) at specific points in time. For example, a liability factor event may include a natural disaster, a loan termination date, a forgiveness date, or the like.

Controller 110 combines all lattices 124 into polynomial lattice 122 (308). For example, controller 110 may combine lattices 124 such that nodes 180 of respective lattices 124, that relate to the same points of time are adjacent each other on polynomial lattice 160. In some examples, controller 110 may combine lattices 124 such that controller 110 may simulate liability scenarios (310) by traversing between adjacent nodes 180 of polynomial lattice 122, such that controller 110 traverses between nodes 180 of different lattices 124 in simulating liability scenarios.

Controller 110 may determine a risk score for asset 130 (312). For example, controller 110 may calculate a number that corresponds to a historical amount of risk of asset 130. Controller 110 may simulate a predetermined number of liability scenarios to determine the risk score. Controller 110 may determine this risk score by averaging out all results of the simulated liability scenarios, or by merging together different versions of the simulated liability scenarios, or the like.

Controller 110 may recommend an action on asset 130 (314). For example, controller 110 may determine whether or not risk score is above or below a threshold of a user that relates to acquiring asset 130. Controller 110 may have received a request to evaluate asset 130 from a given user device, and controller 110 may recommend this action to the user device. For example, controller 110 may provide this recommendation on a user interface used by the user that requested an evaluation of asset 130. This recommendation may include an affirmative or negative, and/or a metric associated with the evaluation of asset 130. In some examples, this recommendation may indicate what liability factors were most impactful in generating the risk score. By providing a recommendation and also providing the most indicative liability factors, controller 110 may enable a user to quickly decide whether or not to take an action for asset 130.

The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to explain the principles of the embodiments, the practical application or technical improvement over technologies found in the marketplace, or to enable others of ordinary skill in the art to understand the embodiments disclosed herein.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be accomplished as one step, executed concurrently, substantially concurrently, in a partially or wholly temporally overlapping manner, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

1. A computer-implemented method comprising:
generating, by a processor, a first lattice that includes nodes of liability factors related to an asset across time;
generating, by the processor, a second lattice that includes nodes of liability factors related to an asset owner across time;
generating, by the processor, a third lattice that includes nodes of liability factors related to economic parameters across time,
wherein each respective node of each respective lattice indicates a possible event that could be realized at a point in time as indicated by that respective node's location on that respective lattice and adjacent nodes logically flow into each other such that a value of one respective node would logically occur sequentially in time in relation to other respective nodes adjacent to the one respective node;
combining, by the processor, the first and second and third lattice into a three-dimensional data structure of a single polynomial lattice;
simulating, by the processor and using a neural network, liability scenarios by capturing traversal of the polynomial lattice by traveling between adjacent nodes of the polynomial lattice;
determining, by the processor, a risk score of the asset by having the neural network analyze the simulated liability scenarios;
providing, by the processor, a first recommendation to buy the asset if the determined risk score is above a threshold, wherein this first recommendation is provided via a first notification within a user interface of a device of the user and the first notification indicates a first subset of liability factors that were most impactful in generating the risk score; and
providing, by the processor, a second recommendation to not buy the asset if the determined risk score is below the threshold, wherein this second recommendation is provided via a second notification within the user interface and the second notification indicates a second subset of liability factors that were most impactful in generating the risk score.

2. The computer-implemented method of claim 1, further comprising simulating, by the processor, a predetermined number of liability scenarios.

3. (canceled)

4. (canceled)

5. The computer-implemented method of claim 1, further comprising teaching, by the processor and via supervised learning techniques, the neural network to more heavily traverse certain types of paths of the polynomial lattice in simulating the liability scenarios.

6. The computer-implemented method of claim 1, further comprising teaching, by the processor and via supervised learning techniques, the neural network to more lightly traverse certain types of paths that are determined to include an unlikely sequence of nodes of the polynomial lattice in simulating the liability scenarios.

7. The computer-implemented method of claim 1, wherein the combining the first and second and third lattice into the single polynomial lattice includes analyzing logical relations between nodes of the first and second and third lattices such that adjacent nodes of the first and second and third lattice are logically related to each other.

8. (canceled)

9. A system comprising:
a processor; and
a memory in communication with the processor, the memory containing instructions that, when executed by the processor, cause the processor to:
generate a first lattice that includes nodes of liability factors related to an asset across time;
generate a second lattice that includes nodes of liability factors related to an asset owner across time;
generate a third lattice that includes nodes of liability factors related to economic parameters across time,
wherein each respective node of each respective lattice indicates a possible event that could be realized at a point in time as indicated by that respective node's location on that respective lattice and adjacent nodes logically flow into each other such that a value of one respective node would logically occur sequentially in time in relation to other respective nodes adjacent to the one respective node;
combine the first and second and third lattice into a three-dimensional data structure of a single polynomial lattice;
simulate, by a neural network, liability scenarios by capturing traversal of the polynomial lattices by traveling between adjacent nodes of the polynomial lattice;
determine a risk score of the asset by having the neural network analyze the simulated liability scenarios;
provide a first recommendation to buy the asset if the determined risk score is above a threshold, wherein this first recommendation is provided via a first notification within a user interface of a device of the user and the first notification indicates a first subset of liability factors that were most impactful in generating the risk score; and
provide a second recommendation to not buy the asset if the determined risk score is below the threshold, wherein this second recommendation is provided via a second notification within the user interface and the second notification indicates a second subset of liability factors that were most impactful in generating the risk score.

10. The system of claim 9, the memory containing additional instructions that, when executed by the processor, cause the processor to simulate a predetermined number of liability scenarios.

11. The system of claim 9, wherein the combining the first and second and third lattice into the single polynomial lattice includes analyzing logical relations between nodes of the first and second and third lattices such that adjacent nodes of the first and second and third lattice are logically related to each other.

12. (canceled)

13. The system of claim 9, the memory containing additional instructions that, when executed by the processor, cause the processor to teach, via supervised learning techniques, the neural network to more heavily traverse certain types of paths of the polynomial lattice in simulating the liability scenarios.

14. The system of claim 9, the memory containing additional instructions that, when executed by the processor, cause the processor to teach, via supervised learning techniques, the neural network to more lightly traverse certain types of paths of the polynomial lattice that are determined to include an unlikely sequence of nodes in simulating the liability scenarios.

15. (canceled)

16. (canceled)

17. A computer program product, the computer program product comprising a computer readable storage medium having program instructions embodied therewith, the program instructions executable by a computer to cause the computer to:
generate a first lattice that includes nodes of liability factors related to an asset across time;
generate a second lattice that includes nodes of liability factors related to an asset owner across time;
generate a third lattice that includes nodes of liability factors related to economic parameters across time,
wherein each respective node of each respective lattice indicates a possible event that could be realized at a point in time as indicated by that respective node's location on that respective lattice and adjacent nodes logically flow into each other such that a value of one respective node would logically occur sequentially in time in relation to other respective nodes adjacent to the one respective node;
combine the first and second and third lattice into a three-dimensional data structure of a single polynomial lattice;
simulate, by a neural network, liability scenarios by capturing traversal of the polynomial lattice by traveling between adjacent nodes of the polynomial lattice;
determine a risk score of the asset by having the neural network analyze the simulated liability scenarios;
provide a first recommendation to buy the asset if the determined risk score is above a threshold, wherein this first recommendation is provided via a first notification within a user interface of a device of the user and the first notification indicates a first subset of liability factors that were most impactful in generating the risk score; and
provide a second recommendation to not buy the asset if the determined risk score is below the threshold, wherein this second recommendation is provided via a second notification within the user interface and the second notification indicates a second subset of liability factors that were most impactful in generating the risk score.

18. The computer program product of claim 17, the computer readable storage medium having additional program instructions that, when executed by the computer, cause the computer to simulate a predetermined number of liability scenarios.

19. The computer program product of claim 17, wherein the combining the first and second and third lattice into the single polynomial lattice includes analyzing logical relations between nodes of the first and second and third lattices such that adjacent nodes of the first and second and third lattice are logically related to each other.

20. The computer program product of claim 17, the computer readable storage medium having additional program instructions that, when executed by the computer, cause the computer to:
teach, via supervised learning techniques, the neural network to more heavily traverse certain types of paths of the polynomial lattice in simulating the liability scenarios; and
teach, via supervised learning techniques, the neural network to more lightly traverse certain types of paths of the polynomial lattice that are determined to include an unlikely sequence of nodes in simulating the liability scenarios.
